(19) United States
(12) Patent Application Publication
(10) Pub. No.: US 2009/0102719 A1
(43) Pub. Date: Apr. 23, 2009

(54) Local location-tracking system

(75) Inventor: Wei-Cheng Lin, Taipei City (TW)

Correspondence Address: BIRCH STEWART KOLASCH & BIRCH, PO BOX 747, FALLS CHURCH, VA, 22040-0747, US

(73) Assignee: Unified Packet Systems Corp.

(21) Appl. No.: 11/984,773

(22) Filed: Nov. 21, 2007

(30) Foreign Application Priority Data
Sep. 21, 2007 (TW) 96135564

(51) Int. Cl. G01S 5/02

(52) U.S. Cl. 342/450

(57) ABSTRACT

A local location-tracking system is installed in an indoor space, and comprises at least one tracked end, a plurality of second wireless signal transceivers and a local control end. The tracked end is movably located within the indoor space, and has at least one first wireless signal transceiver for sending a tracked signal. Each of the second wireless signal transceivers sends a detecting signal to the tracked end, the tracked end generates a response signal in accordance with the detecting signal, and the second wireless signal transceiver sends out a strength signal in accordance with a signal strength of the response signal. The local control end is applied to receive the strength signal and calculating a location coordinate of the tracked end in accordance with the signal strength.

### FIELD OF THE INVENTION

The present invention relates to a location-tracking system, and more particularly to a local location-tracking system installed in an indoor space.

### BACKGROUND OF THE INVENTION

In our daily life, it is necessary for many cases to track a location and a path of a tracked object, which moves in a space. For effectively tracking the tracked object, it is usually necessary to calculate a location coordinate that the tracked object located in via signal detecting and coordinate calculation technologies, and then it is further necessary to display where the tacked object is in accordance with the location coordinate. Among the location-tracking technologies, the global positioning system (GPS) and the global system for mobile communication (GSM) are the most representative thereof.

Due to that it is necessary for the GPS technology to take advantage of many synchronous satellites, so that it would be more economic that only when the GPS technology is applied to execute location tracking in a wide area. Since the GPS technology is not suitable to be applied to execute location tracking in a medium area or a small area, a conventional location-tracking technology is cited as follows to illustrate how to track a tracked object moving in a medium area outdoor space through the GSM technology.

Please refer to FIG. 1, which is a simplified functional block diagram illustrating a location-tracking system in prior arts. As shown in FIG. 1, a location-tracking system comprises a tracked end 11, three outdoor base stations 12, 13 and 14, a central control end 15, and a coordinate display 16. The tracked end 11 is located in a position where is respectively distant from the three outdoor base station in a first distance, a second distance and a third distance, and has a first wireless signal transceiver 111. The outdoor base station 12 comprises a second wireless signal transceiver 121 and a signal processing circuit 122 coupled with the second wireless signal transceiver 121; similarly, the outdoor base station 13 comprises a second wireless signal transceiver 131 and a signal processing circuit 132 coupled with the second wireless signal transceiver 131; and the outdoor base station 14 comprises a second wireless signal transceiver 141 and a signal processing circuit 142 coupled with the second wireless signal transceiver 141. The central control end 15 comprises a third wireless signal transceiver 151 and a coordinate calculator 152 coupled with the third wireless signal transceiver 151. The coordinate display is coupled with the central control end 15.

The second wireless signal transceivers 121, 131 and 141 can send three detecting signals S11, S12 and S13 respectively. The first wireless signal transceiver 111 of the tracked end 11 can respectively send three response signals 511′, S12′ and S13′ in accordance with the detecting signals S11, S12 and S13. The response signals S11′, S12′ and S13′ can be received by the second wireless signal transceivers 121, 131 and 141, and respectively transmitted to the processing circuits 122, 132 and 142 to be processed. Following up, the signal processing circuits 122, 132 and 142 can respectively send three strength signals S21, S22 and S23, in accordance with the signal strengths of the response signals S11′, S12′ and S13′, to the central control end 15 via the second wireless signal transceivers 121, 131 and 141.

The strength signals S21, S22 and S23 can be received by the third wireless signal transceiver 151 and transmitted to the coordinate calculator 152, so as to analyze the value of the signal strength. Due to that the values of the three signal strengths are respectively associated with the first distance, the second distance and the third distance, and the coordinates of the outdoor base stations 12, 13 and 14 located are known, so that the coordinate calculator 152 can calculate the location coordinate of the tracked end 11. Following up, the coordinate calculator 152 can transmit the location coordinate of the tracked end 11 to the coordinate display 16.

Please go on referring to FIG. 2, which illustrates the tracked end is displayed on a map in a form of a location point. As shown in FIG. 2, the coordinate display 16 can display a map 161 where marked with a plurality of building blocks 162. Meanwhile, the location coordinate of the tracked end 11 is displayed in the map 161 in a form of a location point 163 and a two-dimensional coordinate 164.

People skilled in ordinary arts can easily realize that when the tracked end 11 is implemented in a mobile phone, the location-tracking technology can be carried out via the GSM related technologies. However, from the location-tracking technology provided in prior arts, it is obvious that three shortcomings still need to be further improved when the location-tracking technology is carried out in an indoor space.

First, due to the limitation of the resolution scale, when the tracked end 11 is located in a building, it is only able to display which building the tracked end 11 located in through observing which the building block 162 the location point 163 located in; while it is unable to display the exact location of the tracked end 11 within the building.

Second, when the tracked end 11 is located in any communication dead spot within a building, the detecting signals S11, S12 and S13 cannot be effectively received by the tracked end 11, and the tracked end cannot generates the response signals S11′, S12′ and S13′ in accordance with the detecting signals S11, S12 and S13, either. Therefore, it is unable to get the exact location of the tracked end 11.

Third, it is necessary to execute the calculation after the strength signals S21, S22 and S23 are sent to the central control end 15. Once the outdoor base stations 12, 13 and 14 are under a high communication loading condition, the transmission rates of the strength signals S21, S22 and S23 obviously slow down, so that it will be unable to immediately calculate the location coordinate that the tracked end located in due to the reduction of the transmission rates.

### SUMMARY OF THE INVENTION

In the prior arts, there are three major problems of: the resolution scale is insufficient; the detecting signal cannot be received when the tracked end is located in any communication dead spot; and the location coordinate cannot be immediately calculated when the outdoor base stations are under a high communication loading condition. Therefore, the primary objective of the present invention provides a local location-tracking system installed in an indoor space, so as to simultaneously solve above three problems.

Means of the present invention for solving the problems as mentioned above provides a local location-tracking system, which is installed in an indoor space, and comprises at least one tracked end, a plurality of second wireless signal transceivers and a local control end. The tracked end is movably located within the indoor space, and has at least one first wireless signal transceiver. Each of the second wireless signal transceivers sends a detecting signal to the tracked end, the tracked end generates a response signal in accordance with the detecting signal, and the second wireless signal transceiver sends out a strength signal in accordance with a signal strength of the response signal. The local control end is applied to receive the strength signal and calculating a location coordinate of the tracked end in accordance with the signal strength.

In actual applications, it is able to provide a suitable design for the installation locations of the second wireless signal transceivers to ensure that no matter the tracked end located in any location within the indoor space, the response signal generated from the tracked end always can be received by at least two of the second wireless signal transceivers, and effectively send at least two strength signals to the local control end. Therefore, it is able to ensure that no matter the tracked end located in any location within the indoor space, the location coordinate of the tracked end always can be effectively calculated.

With comparison between the prior arts and the present invention, the local location-tracking system is installed in an indoor space with a relative small area, so that it able to define more exact two-dimensional or three-dimensional coordinates to all locations within the indoor space. Thus, the present invention can provide the more exact location coordinate that the tracked end located in. Meanwhile, it is able to provide a suitable design for the installation locations of the second wireless signal transceivers to ensure that no matter the tracked end located in any location within the indoor space, the location coordinate of the tracked end always can be effectively calculated. Nevertheless, all calculation processes of the location coordinate of the tracked end can be carried out in the local control end, so that it is able to immediately calculate the location coordinate of the tracked end.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a simplified functional block diagram illustrating a location-tracking system provided in prior arts;

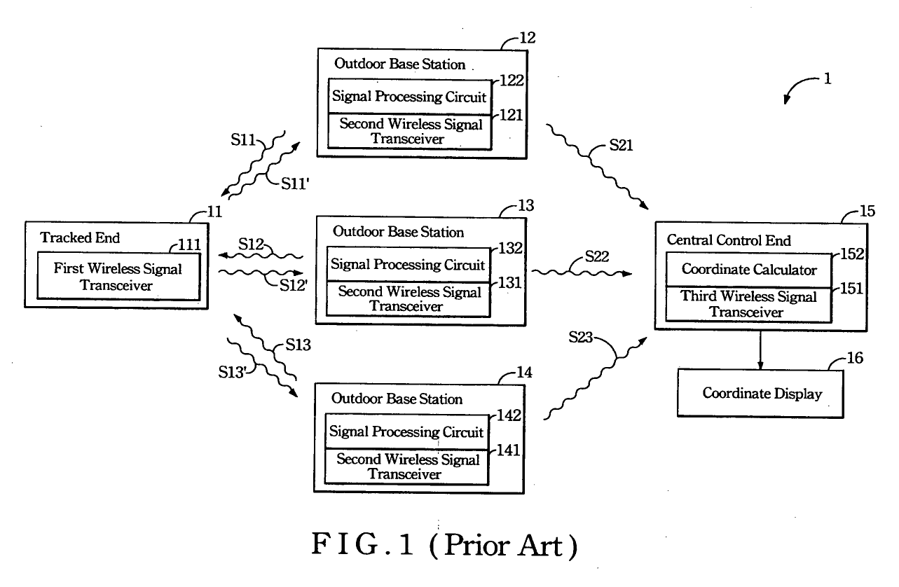

FIG. 2 illustrates the tracked end is displayed on a map in a form of a location point;

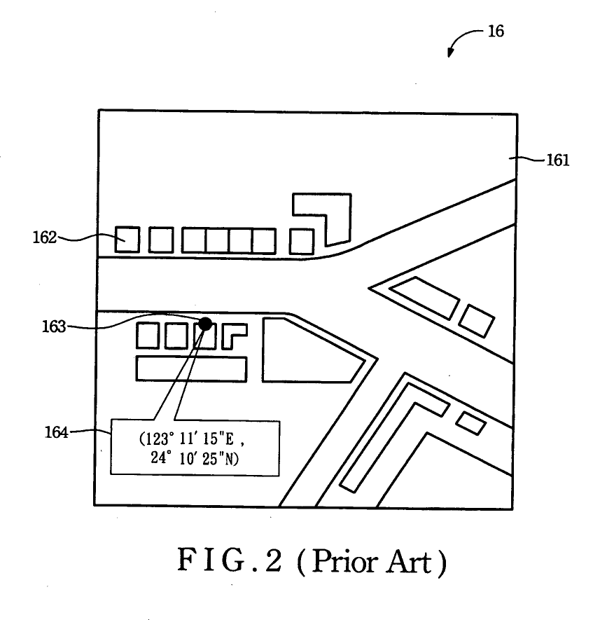

FIG. 3 illustrates an arrangement relation of a preferred embodiment of the present invention;

FIG. 4 illustrates a simplified functional block diagram in accordance with the preferred embodiment of the present invention; and

FIG. 5 illustrates the tracked end is displayed on an indoor space diagram in a form of a location point.

### DETAILED DESCRIPTION OF THE PREFERRED EMBODIMENTS

Due to that the local location-tracking system as provided in accordance with the present invention is applied to use a tracked end to connect to a tracked object, so as to track the location of the tracked object, and the combined applications are too numerous to be enumerated and described, so that only a preferred embodiment is disclosed as follows for representation.

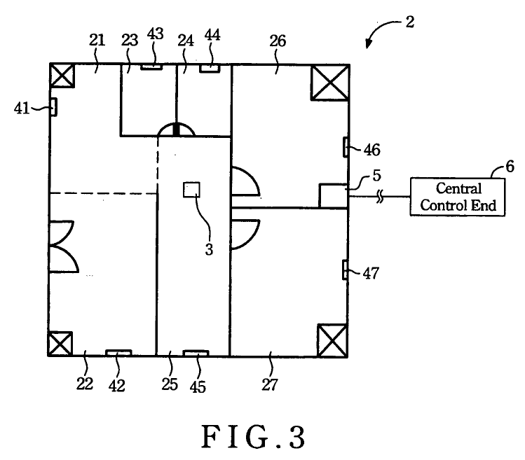

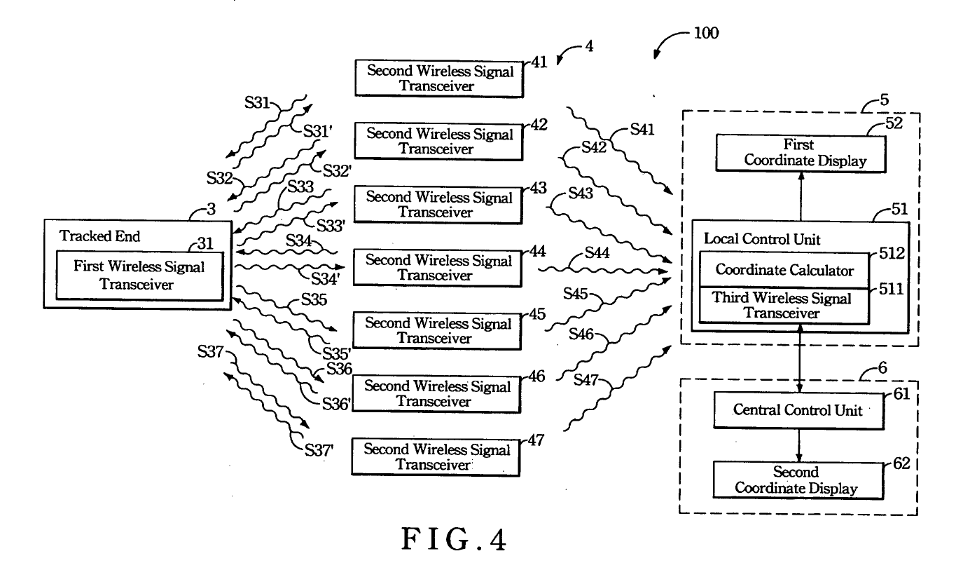

Please refer to FIG. 3 and FIG. 4, wherein FIG. 3 illustrates an arrangement relation of a preferred embodiment of the present invention, and FIG. 4 illustrates a simplified functional block diagram in accordance with the preferred embodiment of the present invention. As shown in the figures, a local location-tracking system 100 is applied to track a location coordinate of a tracked object, which is movably located within an indoor space 2. The indoor space 2 comprises seven indoor sub-spaces 21, 22, 23, 24, 25, 26 and 27. The local location-tracking system 100 comprises a tracked end 3, a transceiver group 4 and a local control end 5.

The tracked end 3 is connected to the tracked object, and has a first wireless signal transceiver 31. Due to that the tracked end is connected to the tracked object, so that the tacked end 3 is also movably located within the indoor space 2 together with the tracked object, and where the location coordinate of the tracked object is located, where the location coordinate of the tracked end is located, too. The transceiver group 4 comprises seven second wireless signal transceiver 41, 42, 43, 44, 45, 46 and 47 respectively located in the indoor sub-spaces 21, 22, 23, 24, 25, 26 and 27. Meanwhile, the second wireless signal transceivers 41, 42, 43, 44, 45, 46 and 47 are respectively distant from the tracked end 3 in a first distance, a second distance, a third distance, a fourth distance, a fifth distance, a sixth distance and a seventh distance.

The local control end 5 comprises a local control unit 51 and a first ordinate display 52 coupled with the local control unit 51. The local control unit 51 comprises a third wireless signal transceiver 511 and an ordinate calculator 52 coupled with the third wireless signal transceiver 51. A central control end 6 is coupled with the local control end 5, and comprises a central control unit 61 and a second coordinate display 62 coupled with the central control unit 61.

The second wireless signal transceivers 41, 42, 43, 44, 45, 46 and 47 can send seven detecting signals S31, S32, S33, S34, S35, S36 and S37 respectively. The detecting signals S31, S32, S33, S34, S35, S36 and S37 can be received by the tracked end 3, and first wireless signal transceiver 31 of the tracked end 3 can respectively send out seven response signals S31′, S32′, S33′, S34′, S35′, S36′ and S37′ in accordance with the detecting signals S31, S32, S33, S34, S35, S36 and S37. The response signals S31′, S32′, S33′, S34′, S35′, S36′ and S37′ can be received and processed by the second wireless signal transceivers 41, 42, 43, 44, 45, 46 and 47. Following up, the second wireless signal transceivers 41, 42, 43, 44, 45, 46 and 47 can respectively send seven strength signals S41, S42, S43, S44, S45, S46 and S46, in accordance with the signal strengths of the response signals S11′, S12′ and S13′, to the local control end 5. In practice applications, the seven signal strengths are embedded in the strength signals S41, S42, S43, S44, S45, S46 and S47 in a form of received signal strength indication (RSSI).

The strength signals S41, S42, S43, S44, S45, S46 and S47 can be received by the third wireless signal transceiver 511, and transmitted to the coordinate calculator 512, so as to analyze the values of the seven signal strength. Due to that the values of the seven signal strengths are respectively associated with the first distance, the second distance, the third distance, the fourth distance, the fifth distance, the sixth distance and the seventh distance, and the coordinates of the outdoor base stations 12, 13 and 14 located are known when they are installed, so that the coordinate calculator 152 can calculate the location coordinate of the tracked end 3.

Following up, the coordinate calculator 512 can transmit the location coordinate of the tracked end 3 to the first coordinate display 52, so as to display the location coordinate of the tracked end 3 on the first coordinate display 52. In the preferred embodiment of the coordinate calculator 512 also can transmit the location coordinate of the tracked end 3 to the central control unit 61 of the central control end 6, so as to display the location coordinate of the tracked end 6 on the second coordinate display 62. Therefore it is obvious that the present invention can be directly connected with the existed central control end 6.

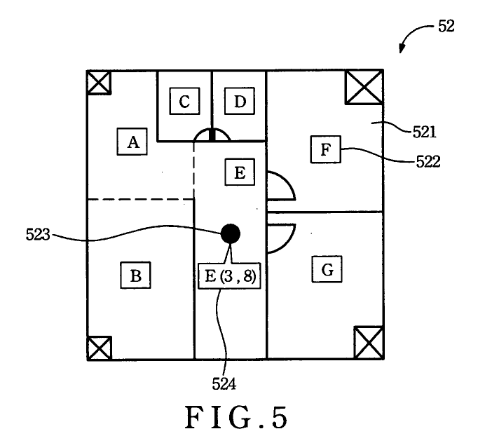

Please go on referring to FIG. 5, which illustrates the tracked end is displayed on an indoor space diagram in a form of a location point, and further refer to FIG. 3 together. As shown in the figures, the first coordinate display 52 can display an indoor space diagram 521 corresponding with the indoor space 2. There are seven sub-space symbols A, B, C, D, E, F and G marked on the indoor space diagram 521 for respectively representing the indoor sub-spaces 21, 22, 23, 24, 25, 26 and 27.

Meanwhile, the location coordinate of the tracked end 3 is displayed on the indoor space diagram 521 in a form of a location point 23 and a two-dimensional coordinate, and the two-dimensional coordinate 524 further comprises the sub-space symbol A, B, C, D, E, F or G so as to clearly display the exact location coordinate of the tracked end 3. It obvious that the two-dimensional coordinate can be replaced by a three-dimensional coordinate. Similarly, it is reasonable that the second coordinate display also can display the location coordinate of the tracked end 3 by the means the same as the first coordinate display 52.

People skilled in ordinary arts can easily realize that in actual, the present invention can be applied to many applications. For example, when the local location-tracking system 100 is installed within an office building, the tracked object can be at least one staff or visitor; the indoor space 2 can be an indoor space of the office building; the indoor sub-spaces 21, 22, 23, 24, 25, 26 and 27 can be seven rooms within the indoor space of the office building; the tracked end 3 can be embedded into an identification card, such as a staff card or a visitor card, which is worn by the staff or the visitor; the local control end 5 can be located in the telephone exchange counter.

When an operator, who works near the telephone exchange counter, gets a call for a staff or a visitor, the operator can immediately know the exact location coordinate of which room the staff or the visitor is located in right now. Therefore, the operator can directly transfer the call to the extension line of the room where the staff or the visitor is located right now, so that the staff or the visitor can instantly get the call.

People skilled in ordinary arts can further realize the facts as follows. The local location-tracking system 100 is installed in an indoor space with a relative small area, so that it able to define more exact two-dimensional or three-dimensional coordinates to all locations within the indoor space 2. Thus, the present invention can provide the more exact location coordinate that the tracked end located in. Meanwhile, it is able to provide a suitable design for the installation locations of the second wireless signal transceivers 41, 42, 43, 44, 45, 46 and 47 to ensure that no matter the tracked end 3 located in any location within the indoor space 2, the location coordinate of the tracked end 3 always can be effectively calculated. Nevertheless, all calculation processes of the location coordinate of the tracked end 3 can be carried out in the local control end 5, so that it is able to immediately calculate the location coordinate of the tracked end 3.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A local location-tracking system installed in an indoor space, and comprising:
at least one tracked end movably located within the indoor space, and having at least one first wireless signal transceiver;
a plurality of second wireless signal transceivers, each one of the second wireless signal transceivers sending a detecting signal to the tracked end, receiving a response signal generated from the tracked end in accordance with the detecting signal, and sending a strength signal in accordance with a signal strength of the response signal; and
a local control end for receiving the strength signal and calculating a location coordinate of the tracked end in accordance with the signal strength.

2. The local location-tracking system as claimed in claim 1, wherein the local control end comprises:
a local control unit, for receiving the strength signal and calculating the location coordinate of the tracked end in accordance with the signal strength of the response signal; and
a first coordinate display coupled with the local control unit for displaying the location coordinate.

3. The local location-tracking system as claimed in claim 2, wherein the location coordinate is displayed in an indoor space diagram.

4. The local location-tracking system as claimed in claim 3, wherein the indoor space comprises a plurality of indoor sub-spaces, and the indoor space diagram is marked with a plurality of sub-space symbols with respect to the indoor sub-spaces.

5. The local location-tracking system as claimed in claim 4, wherein the location coordinate comprises one of the sub-space symbols with respect to one of the indoor sub-spaces that the tracked end located in.

6. The local location-tracking system as claimed in claim 2, wherein the local control unit comprises:
a third wireless signal transceiver for receiving the strength signal; and
a coordinate calculator coupled with the third wireless signal transceiver for analyzing the signal strength of the response signal from the strength signal, and calculating the location coordinate of the tracked end in accordance with the signal strength.

7. The local location-tracking system as claimed in claim 1, wherein the local control end is coupled with a central control end, so as to transmit the location coordinate to the central control end.

8. The local location-tracking system as claimed in claim 7, wherein the local control end comprises:
a central control unit coupled with the local control end for receiving the location ordinate sent from the local control end; and
a second coordinate display coupled with the central control unit for displaying the location coordinate.

9. The local location-tracking system as claimed in claim 8, wherein the location coordinate is displayed in an indoor space diagram.

10. The local location-tracking system as claimed in claim 9, wherein the indoor space comprises a plurality of indoor sub-spaces, and the indoor space diagram is marked with a plurality of sub-space symbols with respect to the indoor sub-spaces.

11. The local location-tracking system as claimed in claim 10, wherein the location coordinate comprises one of the sub-space symbols with respect to one of the indoor sub-spaces that the tracked end located in.

12. The local location-tracking system as claimed in claim 1, wherein the response signal is sent by the first wireless signal transceiver.

13. The local location-tracking system as claimed in claim 1, wherein the tracked end is embedded in an identification card.
